(19) United States
(12) Patent Application Publication
(10) Pub. No.: US 2022/0022465 A1
(43) Pub. Date: Jan. 27, 2022

(54) METHODS AND COMPOSITIONS FOR REPELLING BIRDS IN CROP PLANTS

(71) Applicant: Bayer Aktiengesellschaft, Leverkusen (DE)

(72) Inventors: Mark BARTLETT, Lentilly (FR); Stéphaneé BONNISSOL, Lyon (FR); Bernard DE VERGNES, Méréville (FR); Joerg HAHNE, Leichlingen (DE); Laurence SOUBIEUX, La Mérévillois (FR); Joël DIETENBECK, Haguenau (FR)

(73) Assignee: Bayer Aktiengesellschaft, Leverkusen (DE)

(21) Appl. No.: 17/310,754

(22) PCT Filed: Feb. 20, 2020
(86) PCT No.: PCT/EP2020/054531

§ 371 Date: Aug. 20, 2021

(30) Foreign Application Priority Data
Feb. 22, 2019 (EP) 19158912.6

(51) Int. Cl. A01N 65/42; A01M 29/12

(52) U.S. Cl. CPC A01N 65/42; A01M 29/12

(57) ABSTRACT

The invention provides for compositions and methods that are useful for repelling birds from crop plants, more particularly repelling birds from feeding on crop plant propagation material, e.g. seeds.

### FIELD

Provided herein are compositions and methods that are useful for repelling birds from crop plants, more particularly repelling birds from feeding on crop plant propagation material, e.g. seeds.

### BACKGROUND

Since agriculture has started to sow and grow crops, it had to face with many pests or diseases affecting the planted crop, and therefore the yield. One of the most familiar pest against which growers have since long tried to find solutions is birds. The main problem encountered by growers with birds is that they find the seeds that are freshly sown in the field but also the growing plantlets or the seeds on matured crops as a very attractive and easy source of food to feed on.

Among the largely used solutions tried by growers and gardeners to frighten birds are scarecrows. It is however unfortunately well known that such solutions only have a limited efficacy, especially because of the well-developed cognitive capacities of birds, which learn relatively rapidly that scarecrows are not so scary, irrespective of the creativity of their crafters.

Among the other solutions which have been tried since a few decades are repellent solutions applied on the seeds before, or at the time of, sowing. Many chemicals have been tested, of which some have shown some efficacy. One of the most known chemical having bird repellency effect is the fungicide Thiram. Thiram has since long been shown to be an effective bird repellent, for example against cowbirds and house sparrows (Griffin and Baumgartner, 1958, Proc. Of the Okla. Acad. of Sci., 78-82). Methiocarb (also known as mesurol) has also been reported to show some repelling effect against blackbirds and crows when treated on corn seeds (Stickley and Guarino, 1972, J. Wildlife Management 36(1), 150-152), as well as against various birds when treated on pine seeds (Fuller et al., 1984, Tree Planter's Notes 35(1), 12-17). Turpentine was also tested as bird repellent on sunflower seeds, but its efficacy was considered too limited (Mason and Bonwell, 1993, Crop Protection 12(6), 453-457). Anthraquinone is also known as an efficient bird repellent in seed treatment, and has eventually been commercialized under the brand name Avipel® (Werner et al., 2011, Applied Animal Behaviour Science 129, 162-169).

Spices and aromatic plants have also been tested for their bird repellency potential. One of the best documented is garlic, most particularly a garlic extract usually described as “garlic oil”. For example, such garlic oil has been demonstrated to have some level of repellent effect on European starlings (Hile et al., 2004, J. Agric. Food Chem. 52, 2192-2196). Chili pepper and more particularly its main component, Capsaicin, is also known to be irritating to birds. It has even been commercialized in the form of a bird repellent gel under the brand name AviGo® by the company Rentokil®. There are also several reports indicating that black pepper and its main component piperine have some bird repellent effect. This seems to be so, however, only at high concentrations (0.5 to 1%) where either quails or European starlings reduce their consumption of treated food, whereas food consumption is unaffected at lower doses (Hilmi et al., 2015, Media Peternakan 38(3): 150-155; Mason and Clarke, 1995, Auk 112: 511-514).

However, one important difficulty in identifying a bird repellent product to protect seeds sown in the fields, plantlets germinating therefrom or seeds on ripening crops, is to make sure that the repellent product does not have harmful effects on the seeds and plantlets. A typical effect that repellent products can have on seeds is a toxicity that affects their germination and the growth of the plantlet.

There is currently almost no bird repellent sold on the market as seed treatment, and there is therefore an urgent need in the industry for an effective, economical, and environmentally safe product, e.g. preferably sourced from a biological material, that has a bird repelling effect and that can, at the same time, safely be used on various crop seeds, i.e. without affecting the seed's biology (e.g. its germination).

### SUMMARY

One aspect of the present invention is a plant propagation material treated, or covered, or coated, or dressed, or overspread, or overlaid, with a composition comprising a plant extract selected from the group consisting of: (i) an extract of a pepper plant of the genus Piper, and (ii) an extract of a ginger plant Zingiber officinale.

According to a particular aspect of the invention, the plant extract comprised in the composition is an oleoresin.

According to a certain embodiment, the composition is a composition comprising an extract of a plant of the genus Piper, more specifically an extract of the plant Piper nigrum, even more specifically an extract of the fruits of the plant Piper nigrum.

The invention is also directed to a plant propagation material treated, covered, or coated, or dressed, or overspread, or overlaid, with a composition comprising the compound piperine.

The invention also encompasses a plant propagation material treated, covered, or coated, or dressed, or overspread, or overlaid, with a composition comprising (i) at least 50% v/v of an extract of a plant of the genus Piper and (ii) up to 50% v/v of at least one extract of another plant having a bird repellent effect. According to a specific embodiment, the extract of another plant having a bird repellent effect is an extract of the garlic plant Allium sativum. More specifically, the extract of the garlic plant Allium sativum is an oil obtained by steam distillation of crushed cloves.

The invention is generally directed to a plant propagation material, and it is more specifically suitable to a seed as plant propagation material. Alternatively, it is also suitable to a fruit as plant propagation material. According to the invention, such seed or fruit may be a harvested seed or fruit, or it may be a seed or fruit still maturing on the plant producing it.

The invention is further directed to a field for growing a crop plant, comprising at least one plant propagation material as described above.

The invention is also directed to a method for protecting plant propagation material from birds, comprising the step of treating such plant propagation material with a composition as described above.

Other objects and features will be in part apparent and in part pointed out hereinafter.

### DETAILED DESCRIPTION

Generally, the products, compositions and methods described herein can be applied to many types of plant propagation material, including seeds, but also to plantlets, plants, or the locus where plants grow, wherein the control of birds is desirable.

One aspect of the present disclosure is directed to a plant propagation material treated with a composition comprising a plant extract selected from the group consisting of: (i) an extract of a pepper plant of the genus Piper, and (ii) an extract of a ginger plant Zingiber officinale.

In the context of the present invention, the term “treated” is intended to mean that a process of application of the composition on the plant propagation material is performed, and that the resulting plant propagation material is actually covered, or, in a synonymous meaning, coated, dressed, overspread, or overlaid, with such composition. Accordingly, one aspect of the present disclosure is directed to a plant propagation material covered, or coated, or dressed, or overspread, or overlaid, with a composition comprising a plant extract selected from the group consisting of: (i) an extract of a pepper plant of the genus Piper, and (ii) an extract of a ginger plant Zingiber officinale.

In the context of the present invention, and not differently than the conventional meaning of this term, an “extract” is intended to mean a composition that is obtained by applying a chemical or mechanical process to a given biological material or a part thereof, and that does not contain the complete chemical constituents of the initially extracted material. In this meaning, an “extract” is not a material that has all the constituents of the initially extracted material put in a different shape, i.e. an extract is not a material that is simply ground or powdered. An extract is also not a mere physical part of the material to be extracted, e.g. the leaves or the seeds of a complete plant. An extract is therefore a chemical portion of the initially-extracted material, i.e. in the context of the invention, a chemical portion of a pepper plant of the genus Piper or only of a part thereof, or of a ginger plant Zingiber officinale or only of a part thereof. A similar way to designate an extract is, for example, an “extracted chemical portion”.

According to one aspect, the plant extract is a solvent extract, i.e. the whole plant or only a certain part of the plant is put into contact with a solvent so as to extract certain components of the plant in the solvent. The solvent used for the extraction may be any non-aqueous, organic solvent, for example, ethanol, acetone, ether, dichloroethane, ethyl acetate or hexane. Preferably, the solvent used is a combination of solvents comprising ethyl acetate, acetone and hexane. The extraction may be repeated several times in order to extract most of the extractable component. After solvent extraction, the solvents may be removed, e.g. by evaporation, thereby yielding a semi-solid extract usually qualified as a resin.

A preferred type of plant extract according to the invention is an extract known as oleoresin. An oleoresin is a combination of a two types of extracts: (i) a solvent-extracted resin as described above, and (ii) a distillate obtained by steam distillation. According to this embodiment, the plant extract according to the invention is an oleoresin comprising a solvent-extracted resin of the plant and a distillate obtained from steam distillation of the plant. According to a specific embodiment, the solvent extract and the steam-distilled extract are both obtained from a same plant material, i.e. the parts of the plant used for extraction are first subjected to steam distillation, from which the distillate component is obtained, and then these same parts of the plant used for steam distillation are then subjected to a solvent extraction, from which the resin component is obtained. Alternatively, the distillate component and the resin component can be obtained from different batches of plant material. Both the distillate component and the resin component are then combined together to form the oleoresin.

Oleoresins may contain various proportions of the distillate component and of the resin component so as to obtain oleoresins of various compositions and properties. Oleoresins can also contain additional components that are not plant extracts. Such additional components can, for example, be propylene glycol, triacetin or any other additives that are known to facilitate the mixing of the distillate and resin components and hence improve the properties of the oleoresin.

Accordingly, the plant extract according to the invention is a composition comprising a solvent-extracted resin, i.e. it is either the solvent-extracted resin itself or an oleoresin.

According to a particular embodiment, the plant propagation material is treated, or covered, or coated, or dressed, or overspread, or overlaid, with a composition comprising an extract of plants of the genus Piper. This may include for example the species Piper nigrum or Piper longum. A preferred species of Piper for carrying out the invention is Piper nigrum. This includes the many cultivars and varieties of the species Piper nigrum.

Any parts of the plant of the genus Piper may be used to carry out the invention. According to one aspect of the invention, the plant propagation material is treated with a composition comprising an extract of fruits of the black pepper plant Piper nigrum.

According to the invention, the extract of the black pepper plant Piper nigrum is an extract containing piperine, a compound naturally present in several species of the genus Piper, most notably in the black pepper plant Piper nigrum. Accordingly, the extract is obtained by any means that is able to extract at least piperine. There are many known methods of extraction, such as those described in Gorgani et al. (2017), Comprehensive Reviews in Food Science and Food Safety 16: 124-140. According to one embodiment, the extract is a solvent extract. The solvent used for the extraction may be any non-aqueous, organic solvent, for example, ethanol, acetone, ether, dichloroethane, ethyl acetate or hexane. Preferably, the solvent used is a combination of solvents comprising ethyl acetate, acetone and hexane. The extraction may be repeated several time in order to extract most of the extractable component. After solvent extraction, solvents may be removed, e.g. by evaporation, thereby yielding a semi-solid extract qualified as resin.

A preferred type of extract according to the invention is an oleoresin, comprising a mixture of a steam distillate of the black pepper plant Piper nigrum and a solvent-extracted resin of the black pepper plant Piper nigrum.

A particular aspect of the present disclosure is therefore directed to a plant propagation material treated, or covered, or coated, or dressed, or overspread, or overlaid, with an oleoresin of fruits of the black pepper plant Piper nigrum.

Black pepper solvent extracts, or compositions comprising such extracts like oleoresins, contain the compound piperine (Gorgani et al., 2017, Comprehensive Reviews in Food Science and Food Safety, Vol. 16: 124-140).

Oleoresins of black pepper Piper nigrum may contain various proportions of the distillate component and of the resin component so as to obtain an oleoresin with desired quantities of piperine. Oleoresins may contain from 10% to 60% of piperine. Depending on the requirements, oleoresins with various proportions of piperine can be obtained by mixing appropriate quantities of the resin and the distillate, and dosing the piperine in the oleoresin. Piperine content can be measured using a standard protocol, more particularly by measuring absorbance after extraction in ethanol, at a maximal absorbance of 342-345 nm under exposure by a UV light source. Oleoresins may contain at least 10%, 15%, 20%, 25%, 30%, 35%, 40%, 45%, 50%, 55%, 60% of piperine. According to a specific embodiment, an oleoresin of black pepper Piper nigrum comprises 38% of piperine. Oleoresins may also contain various proportions of volatile oils depending on the quantity of distillate introduced for its preparation.

The invention may also be carried out with chemically-synthesized piperine (Olsen and Spessard, 1981, J. Agric. Food Chem. 29: 942-944). Accordingly, the invention is also directed to a plant propagation material treated, or covered, or coated, or dressed, or overspread, or overlaid, with piperine.

A preferred source for the extract of plants of the genus Piper is the fruit of such plants, most particularly the fruits of the black pepper plant Piper nigrum. The fruits of the black pepper plant Piper nigrum from which the extract is obtained may be in any form, i.e. fresh or dried fruits, ripe or unripe, cooked or uncooked. Preferably, the fruits of the black pepper plant Piper nigrum from which the extract is obtained are in the form of cooked and dried unripe fruits. In order to improve the extraction process, the fruits are crushed before being subject to steam distillation and/or put in contact with one or more solvent.

A preferred source for the extract of the ginger plant Zingiber officinale is the rhizome of such plants. Preferably, the rhizome is dried and crushed or powdered before being subjected to extraction. According to such embodiment, the extract may be a solvent extract or an oleoresin of the ginger plant Zingiber officinale. For the preparation of an oleoresin of the ginger plant Zingiber officinale, the rhizomes of the ginger plant are dried and crushed and then subjected to steam distillation to obtain a steam distillate and to solvent extraction to obtain a resin, that are then combined together in desired proportions. The solvent-extracted resins and oleoresins contain the compound gingerol.

The extract of plants of the genus Piper or the extract of the ginger plant Zingiber officinale is also one that does not naturally contain an effective bird-repellent amount of the compound anthraquinone.

The inventors have found out that plant propagation materials, in particular seeds, that are treated, or covered, or coated, or dressed, or overspread, or overlaid, with a composition comprising an extract of fruits of the black pepper plant Piper nigrum or an extract of rhizomes of the ginger plant Zingiber officinale, are much less attractive for consumption by birds than if not treated with such a composition. The extract of fruits of the black pepper plant Piper nigrum or the extract of rhizomes of the ginger plant Zingiber officinale therefore act as repellents to birds, or make the plant propagation materials unpalatable to birds. When the plant propagation materials, e.g. seeds, that are treated, or covered, or coated, or dressed, or overspread, or overlaid, with a composition of the invention are “repellent” or “unpalatable” to birds, it means that their consumption by birds is reduced compared to untreated plant propagation materials, e.g. seeds, i.e. compared to plant propagation material that is not covered, or coated, or dressed, or overspread, or overlaid, with such composition. Importantly, the inventors have also found that, contrary to some other plant extracts which may also be repellent to birds, extracts of fruits of the black pepper plant Piper nigrum or extracts of rhizomes of the ginger plant Zingiber officinale have the great advantage to be safe for the plant propagation materials, e.g. the seeds, that are treated with. For example, extracts of fruits of chili pepper plants of the genus Capsicum, more particularly Capsicum annuum, which are known to have some repellent effect on birds, appear to be unsafe to seeds, and can therefore not be used to treat seed. Same, as demonstrated by the inventors, for the extracts of clove Syzygium aromaticum.

One important advantage of the compositions according to the invention is that they are safe to plant propagation materials, in particular to seeds. Safe to plant propagation materials, in particular seeds, in the context of the present invention means that the capacity of such plant propagation materials or seeds to germinate and to grow a fully fertile plant is not affected by the treatment, covering, coating, dressing, overlay, or overspray, of such plant propagation materials or seeds with the compositions of the invention.

In the case of seeds, but this is generally also true for other types of plant propagation materials, the natural capacity to germinate and to grow fully fertile plants is generally variable among the seeds of a same plant species or even plant variety. This is due to the fact that a certain small percentage of non-viable seeds are systematically produced by plants. In the seeds production industry, this may also be due to certain damages caused to some seeds during the various processing steps of the seeds in the process of seed production. Usually, that percentage of non-viable seeds is low, i.e. in the range of less than 5 percent. It may however be different, ideally lower but sometimes higher, depending on the type of plant or plant variety from which the seeds are produced, but also on the quality of the seed production process. The capacity of seeds to germinate and to grow fully fertile plants is therefore to be understood as referring to an average capacity assessed on several seeds, preferably at least 10 seeds, but more preferably 50 or 100 seeds.

Accordingly, the treated, or covered, or coated, or dressed, or overspread, or overlaid, plant propagation material, in particular the treated, or covered, or coated, or dressed, or overspread, or overlaid, seeds, according to the invention are plant propagation materials or seeds whose capacity to germinate and to grow a fully fertile plant is not significantly affected by their treatment, covering, coating, dressing, overlay, overspray, with the compositions of the invention.

The compositions according to the invention and the plant propagation materials, in particular seeds, treated, or covered, or coated, or dressed, or overspread, or overlaid, with such compositions are repellent and/or unpalatable to birds. The birds relevant in the context of the present invention are birds living freely in the wild, i.e. so-called wild birds, and not so-called domestic birds that are raised by man and retained in captivity for that purpose in any closed area, be it a cage, a warehouse, an area covered by a net, or even one that is not covered in case of birds that are not able, or disabled, to fly. However, certain birds are first raised in captivity and then later released in the wild, generally once adult, and such birds are also relevant to the present invention, at least for the part of their life when they are freely living in nature. All birds relevant to the invention can therefore be characterized as free-living birds, whether they spend their entire life in nature, or they first are raised by man and later released in nature. The birds relevant to the invention can therefore also be characterized as non-captive birds, or birds not in captivity. They can also be characterized as birds with the exception of domestic, or captive, birds. In the context of seeds as plant propagation material, the compositions of the invention are repellent and/or unpalatable to birds whose food is made, partially or entirely, of plant seeds. Such birds are usually referred to as seed-eating birds or granivorous birds. According to such embodiment, the invention is most useful against birds feeding on crop seeds. Birds feeding on crop seeds include, for example, birds of the family Corvidae, more specifically of the genus Corvus, like e.g. the rook Corvus frugilegus, the carrion crow Corvus corone, or the western jackdaw Corvus monedula. Birds feeding on crop seeds also include for example, birds of the family Columbidae, more specifically of the genus Columba, like e.g. the common wood pigeon Columba palumbus, the rock dove or feral pigeon Columba livia, or also the collared dove Streptopelia decaocto. Birds feeding on crop seeds also include for example, birds of the family Phasianidae, more specifically of the genus Phasianus, like e.g. the common pheasant Phasianus colchicus, or of the genus Perdix, like e.g. the grey partridge Perdix perdix. The common starling Sturnus vulgaris is also such a well-known crop seeds-eating bird.

The seeds according to the invention may be any seeds from any plants.

Preferably, the seeds according to the invention are seeds of crop plants, i.e. seeds of cultivated plants. Seeds are attractive to birds both at the time when they are sown individually, and at the time when they are on the matured plants that produce them. Accordingly, the invention is applicable to isolated and processed seeds that are ready for being sown. Such seeds may be treated, or covered, or coated, or dressed, or overspread, or overlaid, with the composition of the invention either before sowing, whereby the composition is coated onto the seeds, or they may be treated before or after sowing at the sowing plots and rows. The seeds may also still be present on the plant that produces them, for example when they have matured and have not yet been harvested. Such seeds may be directly exposed, such as seeds of cereals or of sunflower, or they may be borne by, or embedded in, a fruit. Both types of seeds are concerned with the invention. According to a particular embodiment, the seeds according to the invention are seeds that are present in a field in which they are placed for being grown or in which they have been grown, in which latter case the seeds are present on the ripening plants.

Accordingly, the invention is also directed to a field comprising seeds treated with a composition according to the invention.

The seeds or other plant propagation materials according to the invention may also be stored seeds that are packed in containers like e.g. bags or boxes. Accordingly, the invention also encompasses any type of container like bags or boxes containing the seeds or other plant propagation materials according to the invention.

Many crop plants are not cultivated from a seed, but rather by vegetative propagation. Vegetative propagation is a form of plant reproduction that does not involve sexual crossing, but that makes use of the capacity of certain plants to grow a new plant from a part of a parent plant. Such part of the parent plant may be any part depending on the plant concerned. It may also be a specialized reproductive organ in certain plants. Specialized reproductive organ from which a new plant can grow can be rhizomes, tubers, bulbs, runners, corms or suckers.

Examples of crop plants growing from such organs are potatoes (tubers), onions, garlic, shallots (bulbs), apple trees, cherry trees, banana trees (suckers). Parts of plants that can be used as planting material to grow new plants may be stem or leaf cuttings. Example of a crop plant that can grow from cuttings is sugarcane (stem cuttings).

Overall, the compositions according to the invention can therefore be applied on various types of plant parts used for the reproduction of new plants. These plant parts include the seeds and fruits, but also all vegetative propagation parts of the plants. For the purpose of the present invention, all these plant parts can be covered under the term “plant propagation material” or “plant reproduction material”, which therefore includes all sexually-produced material (seeds and fruits) and asexually-produced material (plant parts for vegetative propagation).

Accordingly, the invention is also directed to a plant propagation material treated, or covered, or coated, or dressed, or overspread, or overlaid, with a composition comprising a plant extract selected from the group consisting of: (i) an extract of a pepper plant of the genus Piper and (ii) an extract of a ginger plant Zingiber officinale. In a particular embodiment, the extract of a pepper plant of the genus Piper is an extract of the plant Piper nigrum.

According to a particular embodiment, the plant propagation material is a seed. According to another embodiment, the plant propagation material is a plant part for vegetative reproduction. Plant propagation material, be it seeds or any plant part for vegetative reproduction, according to the invention is a plant propagation material that is viable, in the sense that it can be sown and grown into a fertile plant. The plant propagation material according to the invention is therefore not one that has been prepared for food or feed purposes, i.e. not one that has for example been fermented, cooked or roasted. Accordingly, the plant propagation material of the invention is a viable, unfermented, uncooked or unroasted plant propagation material. It can therefore also be characterized as plant propagation material, with the exception of plant propagation material that is prepared for food or feed purposes, or alternatively, with the exception of plant propagation material that has been fermented, cooked or roasted.

Crop plants may be plants which can be obtained by conventional breeding and optimization methods or by biotechnological, genetic engineering, or gene editing methods or combinations of these methods, including genetically modified plants (GMO or transgenic plants) and plant cultivars or varieties which are protectable and non-protectable by plant breeders' rights.

Genetically modified plants (GMO or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome. This gene gives the transformed plant new or improved agronomic or other properties by expressing a protein or polypeptide of interest or by downregulating or silencing other gene(s) which are present in the plant (using for example, antisense technology, cosuppression technology, RNA interference—RNAi—technology or microRNA—miRNA—technology). A heterologous gene that is located in the genome is also called a transgene. A transgene that is defined by its particular location in the plant genome is called a transformation or transgenic event.

Seeds or plant propagation materials of crop plants which may be treated, or covered, or coated, or dressed, or overspread, or overlaid, in accordance with the compositions of the invention include seeds or plant propagation materials of the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelhferae sp., Cruciferae sp., Chenopodiaceae sp., Cucurbitaceae sp. (for example cucumber), Alliaceae sp. (for example leek, onion); major crop plants, such as Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example peas, beans, peanuts), Papilionaceae sp. (for example soya bean), Solanaceae sp. (for example potatoes), Chenopodiaceae sp. (for example sugar beet, fodder beet, swiss chard, beetroot); useful plants and ornamental plants for gardens and wooded areas; including genetically modified versions of each of these plants.

According to a particular embodiment, seeds or plant propagation materials of crop plants which may be treated, or covered, or coated, or dressed, or overspread, or overlaid, in accordance with the compositions of the invention are seeds or plant propagation materials from maize (Zea mays), soybean (Glycine max), cotton (Gossypium hirsutum), wheat (Triticum aestivum), oilseed rape (Brassica napus), rice (Oryza sativa), sunflower (Helianthus annuus), barley (Hordeum vulgare), peas (Pisum sativum), beans (Phaseolus sp., Vicia sp., Vigna sp.).

Plants and plant cultivars, the seeds of which may be treated, or covered, or coated, or dressed, or overspread, or overlaid, according to the invention include plants and plant cultivars which are resistant against one or more biotic stresses, i.e. said plants show a better defense against animal and microbial pests, such as against nematodes, insects, mites, phytopathogenic fungi, bacteria, viruses and/or viroids.

Plants and plant cultivars, the seeds of which may be treated, or covered, or coated, or dressed, or overspread, or overlaid, according to the invention include those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars, the seeds of which may be treated, or covered, or coated, or dressed, or overspread, or overlaid, according to the invention include those plants characterized by enhanced yield characteristics. Increased yield in said plants may be the result of, for example, improved plant physiology, growth and development, such as water use efficiency, water retention efficiency, improved nitrogen use, enhanced carbon assimilation, improved photosynthesis, increased germination efficiency and accelerated maturation. Yield may furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants and plant cultivars, the seeds of which may be treated, or covered, or coated, or dressed, or overspread, or overlaid, according to the invention include plants and plant cultivars which are hybrid plants that already express the characteristic of heterosis or hybrid vigor which results in generally higher yield, vigor, health and resistance towards biotic and abiotic stresses.

Plants and plant cultivars (obtained by plant biotechnology methods such as genetic engineering), the seeds of which may be treated, or covered, or coated, or dressed, or overspread, or overlaid, according to the invention include plants and plant cultivars which are herbicide-tolerant plants, i.e. plants made tolerant to one or more given herbicides. Such plants can be obtained either by genetic transformation, or by selection of plants containing a mutation imparting such herbicide tolerance.

Plants and plant cultivars (obtained by plant biotechnology methods such as genetic engineering), the seeds of which may be treated, or covered, or coated, or dressed, or overspread, or overlaid, according to the invention include plants and plant cultivars which are insect-resistant transgenic plants, i.e. plants made resistant to attack by certain target insects. Such plants can be obtained by genetic transformation, or by selection of plants containing a mutation imparting such insect resistance.

Plants and plant cultivars (obtained by plant biotechnology methods such as genetic engineering), the seeds of which may be treated, or covered, or coated, or dressed, or overspread, or overlaid, according to the invention include plants and plant cultivars which are disease-resistant transgenic plants, i.e. plants made resistant to attack by certain target insects. Such plants can be obtained by genetic transformation, or by selection of plants containing a mutation imparting such insect resistance.

Plants and plant cultivars (obtained by plant biotechnology methods such as genetic engineering), the seeds of which may be treated, or covered, or coated, or dressed, or overspread, or overlaid, according to the invention include plants and plant cultivars which are tolerant to abiotic stresses. Such plants can be obtained by genetic transformation, or by selection of plants containing a mutation imparting such stress resistance.

Plants and plant cultivars (obtained by plant biotechnology methods such as genetic engineering), the seeds of which may be treated, or covered, or coated, or dressed, or overspread, or overlaid, according to the invention include plants and plant cultivars which show altered quantity, quality and/or storage-stability of the harvested product and/or altered properties of specific ingredients of the harvested product.

Plants and plant cultivars (obtained by plant biotechnology methods such as genetic engineering), the seeds of which may be treated, or covered, or coated, or dressed, or overspread, or overlaid, according to the invention include plants and plant cultivars, such as cotton plants, with altered fiber characteristics. Such plants can be obtained by genetic transformation, or by selection of plants contain a mutation imparting such altered fiber characteristics.

Plants and plant cultivars (obtained by plant biotechnology methods such as genetic engineering), the seeds of which may be treated, or covered, or coated, or dressed, or overspread, or overlaid, according to the invention include plants and plant cultivars, such as oilseed rape or related Brassica plants, with altered oil profile characteristics. Such plants can be obtained by genetic transformation, or by selection of plants contain a mutation imparting such altered oil profile characteristics.

Plants and plant cultivars (obtained by plant biotechnology methods such as genetic engineering), the seeds of which may be treated, or covered, or coated, or dressed, or overspread, or overlaid, according to the invention include plants and plant cultivars, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering.

Plants and plant cultivars (obtained by plant biotechnology methods such as genetic engineering), the seeds of which may be treated, or covered, or coated, or dressed, or overspread, or overlaid, according to the invention include plants and plant cultivars, such as Tobacco plants, with altered post-translational protein modification patterns.

Another aspect of the invention is directed to a plant propagation material treated, or covered, or coated, or dressed, or overspread, or overlaid, with a composition comprising (i) at least 50% v/v of an extract of fruits of the black pepper plant Piper nigrum and (ii) up to 50% v/v of at least one extract of another plant having a bird repellent effect. According to a specific embodiment, the plant propagation material is a seed.

According to this embodiment, the “at least one extract of another plant having a bird repellent effect” may be any plant extract having both a bird repellent effect (i.e. a bird reduced-food consumption effect) and being safe to the concerned plant propagation material, more particularly the seed, at the doses used. Examples of such plant extracts may be extracts from the ginger plant Zingiber officinale.

According to another aspect, the invention is directed to a plant propagation material treated, or covered, or coated, or dressed, or overspread, or overlaid, with a composition comprising (i) at least 50% v/v of an extract of fruits of the black pepper plant Piper nigrum and (ii) up to 50% v/v of an extract of cloves of the garlic plant Allium sativum.

According to a further aspect, the invention is directed to a plant propagation material treated, or covered, or coated, or dressed, or overspread, or overlaid, with a composition comprising (i) between 70% and 95% v/v of an extract of fruits of the black pepper plant Piper nigrum, and (ii) 5% to 30% v/v of an extract of cloves of the garlic plant Allium sativum.

More specifically, the invention is directed to a plant propagation material treated, or covered, or coated, or dressed, or overspread, or overlaid, with a composition comprising (i) 90% v/v of an extract of fruits of the black pepper plant Piper nigrum, and (ii) 10% v/v of an extract of cloves of the garlic plant Allium sativum.

According to a specific aspect of the invention, the extract of fruits of the black pepper plant Piper nigrum is an oleoresin obtained from crushed pepper fruits.

The extract of cloves of the garlic plant Allium sativum may be obtained from fresh or dried cloves, which may then be crushed or powdered. According to a specific aspect of the invention, the extract of cloves of the garlic plant Allium sativum is a distillate, in the form of an oil, obtained by steam distillation of crushed dried cloves.

A specific embodiment of the invention is therefore directed to a plant propagation material, particularly a seed, treated, or covered, or coated, or dressed, or overspread, or overlaid, with a composition comprising an oleoresin of fruits of the black pepper plant Piper nigrum and an oil of cloves of the garlic plant Allium sativum, in the proportions set forth above.

### Application to Seeds

The invention is related to a plant propagation material, particularly a seed, treated, or covered, or coated, or dressed, or overspread, or overlaid, with a composition that is repellent or unpalatable to birds.

Accordingly, the invention also relates to a method for protecting plant propagation material, particularly seeds, from birds, wherein such plant propagation material, particularly seeds, is treated, or covered, or coated, or dressed, or overspread, or overlaid, with a composition according to the invention that is repellent or unpalatable to birds.

For example, in one aspect, the invention comprises administering a composition comprising an extract of fruits of the black pepper plant Piper nigrum to seeds, wherein the application rate of the composition is at least about one (1) gram per unit of seeds or at least about 5, 10, 15, 20, 25, 30, 40, 45, 50, 75, or 90 grams per unit of seeds. A “unit of seeds” according to the present invention refers to a quantity of seeds corresponding to 50 000 seeds. The method may comprise administering the composition at an application rate of from about one (1) to about 100, from about 5 to about 95, or from about 10 to about 90 grams per unit of seeds.

The application rate may depend on the type of seeds to be treated, and a person skilled in the art would know how to adapt the dose depending on the type of seeds. As guidance, it is proposed that, (i) for corn seeds, the application rate is about 20 to about 100 gram per unit of seeds, about 30 to about 90 gram per unit of seeds, or about 30 to 50 gram per unit of seeds; (ii) for wheat seeds, the application rate is about one (1) to about 20 gram per unit of seeds, about 2 to about 19 gram per unit of seeds, or about 5 to 18 gram per unit of seeds; (iii) for sunflower seeds, the application rate is about one (1) to about 50 gram per unit of seeds, about 2 to about 48 gram per unit of seeds, or about 5 to 45 gram per unit of seeds. Depending on the type of seeds, the person skilled in the art would also know how to convert these proposed application rates to a corresponding application rate per weight of seeds (e.g. kg) and/or to a corresponding application rate per sowing surface (e.g. hectare).

In another aspect, the invention comprises administering a composition comprising an extract of rhizomes of the ginger plant Zingiber officinale to seeds, wherein the application rate of the composition is at least about one (1) gram per unit of seeds or at least about 5, 10, 15, 20, 25, 30, 40, 45, 50, 75, or 90 grams per unit of seeds. The method may comprise administering the composition at an application rate of from about one to about 100, from about 5 to about 95, or from about 10 to about 90 grams per unit of seeds.

The method may comprise administering the composition comprising an extract of fruits of the black pepper plant Piper nigrum and an extract of cloves of the garlic plant Allium sativum in a combined application rate of at least about 5, 10, 15, 20, 25, 30, 40, 45, 50, 60, 70, or 90 grams per unit of seeds. The method may comprise administering the composition at an application rate of from about 20 to about 70, from about 30 to about 60, or from about 40 to about 50 grams per unit of seeds.

The seed treatment methods described herein can be used in connection with any species of plant and/or the seeds thereof. The methods are used in connection with seeds that are agronomically important. The seed may be a transgenic seed from which a transgenic plant can grow and incorporates a transgenic event that confers, for example, tolerance to a particular herbicide or combination of herbicides, increased disease resistance, enhanced tolerance to insects, drought, stress and/or enhanced yield. The seed may comprise a breeding trait, including for example, in one embodiment a disease tolerant breeding trait. In another embodiment, the seed includes at least one transgenic and breeding trait.

The treatment method may comprise applying a treatment composition to a seed, or other plant propagation material, prior to sowing the seed, so that the sowing operation is simplified. In this manner, seeds, or other plant propagation materials, can be treated, or covered, or coated, or dressed, or overspread, or overlaid, for example, at a central location and then distributed for planting. This may permit a person who plants the seeds to avoid the complexity and effort associated with handling and applying the seed treatment compositions, and to merely plant the treated, or covered, or coated, or dressed, or overspread, or overlaid, seeds in a manner that is conventional for regular untreated seeds.

The treatment composition can be applied to seeds, or other plant propagation material, by any standard seed treatment methodology, including but not limited to mixing in a container (e.g., a bottle or bag), mechanical application, tumbling, spraying, immersion, and solid matrix priming. Seed coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017, among others. Any conventional active or inert material can be used for contacting seeds with the seed treatment composition, such as conventional seed coating materials including but not limited to water-based seed coating materials.

For example, the seed treatment composition can be covered, or coated, or dressed, or overspread, or overlaid, onto a seed by use of solid matrix priming. For example, a quantity of the seed treatment composition can be mixed with a solid matrix material and then the seed can be placed into contact with the solid matrix material for a period to allow the seed treatment composition to be covered, or coated, or dressed, or overspread, or overlaid, to the seed. The seed can then optionally be separated from the solid matrix material and stored or used, or the mixture of solid matrix material plus seed can be stored or planted directly. Non-limiting examples of solid matrix materials which are useful include polyacrylamide, starch, clay, silica, alumina, soil, sand, polyurea, polyacrylate, or any other material capable of absorbing or adsorbing the seed treatment composition for a time and releasing the fungicide(s) of the seed treatment composition into or onto the seed. It is useful to make sure that the seeds treatment composition and the solid matrix material are compatible with each other. For example, the solid matrix material should be chosen so that it can release the seeds treatment composition at a reasonable rate, for example over a period of minutes, hours, days, or weeks.

Imbibition is another method of treating seed with the seed treatment composition. For example, a plant seed can be directly immersed for a period of time in the seed treatment composition. During the period that the seed is immersed, the seed takes up, or imbibes, a portion of the seed treatment composition. Optionally, the mixture of plant seed and the seed treatment composition can be agitated, for example by shaking, rolling, tumbling, or other means. After imbibition, the seed can be separated from the seed treatment composition and optionally dried, for example by patting or air drying.

The seed treatment composition may be applied to the seeds using conventional film techniques and machines, such as fluidized bed techniques, the roller mill method, rotostatic seed treaters, and drum coaters. Other methods, such as spouted beds may also be useful. The seeds may be pre-sized before coating. After or simultaneously to coating, the seeds are optionally dried and then optionally transferred to a sizing machine for sizing. Such procedures are generally known in the art.

If the seed treatment composition is applied to the seed in the form of a coating, the seeds can be coated using a variety of methods known in the art. For example, the coating process can comprise spraying the seed treatment composition onto the seed while agitating the seed in an appropriate piece of equipment such as a tumbler or a pan granulator.

When coating seed on a large scale (for example a commercial scale), the seed coating may be applied using a continuous process. Typically, seed is introduced into the treatment equipment (such as a tumbler, a mixer, or a pan granulator) either by weight or by flow rate. The amount of treatment composition that is introduced into the treatment equipment can vary depending on the seed weight to be coated, surface area of the seed, the concentration of active ingredients in the treatment composition, the desired concentration on the finished seed, and the like. The treatment composition can be applied to the seed by a variety of means, for example by a spray nozzle, a revolving disc or spinning disc. The amount of liquid may be determined by the assay of the formulation and the required rate of active ingredient necessary for efficacy. As the seed falls into the treatment equipment, the seed can be treated (for example by misting or spraying with the seed treatment composition) and passed through the treater under continual movement/tumbling where it can be coated evenly and dried before storage or use.

Alternatively, the seed coating may be applied using a batch process. For example, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In a further alternative embodiment, the seed coating may be applied using a semi-batch process that incorporates features from each of the batch process and continuous process embodiments set forth above.

Seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry.

Seeds can also be coated by placing the known amount of seed into a bottleneck or receptacle with a lid. While tumbling, the desired amount of seed treatment composition can be added to the receptacle. The seed is tumbled until it is coated with the treatment composition. After coating, the seed can optionally be dried, for example on a tray.

The treated seeds may also be enveloped with a film overcoating to protect the bird repellent coating. Such overcoatings are known in the art and may be applied using conventional fluidized bed and drum seed coating techniques. The overcoatings may be applied to seeds that have been treated with any of the seed treatment techniques described above, including but not limited to solid matrix priming, imbibition, coating, and spraying, or by any other seed treatment technique known in the art.

Application to Plants and/or Soil

Another aspect of the disclosure is generally related to protecting a plant propagation material and/or a seed against damage by birds. For example, in one aspect, a composition comprising an extract of a pepper plant of the genus Piper is supplied to a plant propagation material and/or a seed exogenously. Typically, the composition is applied to the plant propagation material, the seed, and/or the surrounding soil where they are sown through sprays, drips, and/or other forms of liquid application.

In one aspect, the composition comprising an extract of a pepper plant of the genus Piper is directly applied to soil surrounding a seed or other plant propagation material, to a plantlet or to a ripening plant producing seeds.

The application may be performed using any method or apparatus known in the art, including but not limited to hand sprayer, mechanical sprinkler, or irrigation, including drip irrigation.

For example, the composition according to the invention may be applied to plants and/or soil using a drip irrigation technique. Preferably, the composition is applied directly to the base of the plants or the soil immediately adjacent to the plants. The composition may be applied through existing drip irrigation systems. This procedure is particularly preferred for use in connection with cotton, strawberries, tomatoes, potatoes, vegetables, and ornamental plants.

In another example, the treatment composition may be applied to plants and/or soil using a drench application. Preferably, a sufficient quantity of the treatment composition is applied such that it drains through the soil to the root area of the plants. The drench application technique is particularly preferred for use in connection with turf grasses and crop plants, including corn.

In some embodiments, the composition is applied to soil after planting. In other embodiments, however, the composition may be applied to soil during planting. In other embodiments, however, the composition may be applied to soil before planting. When the composition is applied directly to the soil, it may be applied using any method known in the art. For example, it may be tilled into the soil or applied in furrow.

### Seed, Plant, or Soil Treatment Compositions

Another embodiment of the disclosure is generally related to a treatment composition comprising an extract of a pepper plant of the genus Piper or of a ginger plant Zingiber officinale as described herein for use in accordance with the methods for preparation of the treated seeds described herein.

Generally, the compositions described herein can comprise any adjuvants, excipients, or other desirable components known in the art. For example, in some embodiments, the treatment composition further comprises a surfactant.

Examples of anionic surfactants include alkyl sulfates, alcohol sulfates, alcohol ether sulfates, alpha olefin sulfonates, alkylaryl ether sulfates, arylsulfonates, alkylsulfonates, alkylaryl sulfonates, sulfosuccinates, mono- or diphosphate esters of polyalkoxylated alkyl alcohols or alkyl phenols, mono- or disulfosuccinate esters of alcohols or polyalkoxylated alkanols, alcohol ether carboxylates, phenol ether carboxylates. In one embodiment, the surfactant is an alkylaryl sulfonate.

Non-limiting examples of commercially available anionic surfactants include sodium dodecylsulfate (Na-DS, SDS), MORWET D-425 (a sodium salt of alkyl naphthalene sulfonate condensate, available from Akzo Nobel), MORWET D-500 (a sodium salt of alkyl naphthalene sulfonate condensate with a block copolymer, available from Akzo Nobel), sodium dodecylbenzene sulfonic acid (Na-DBSA) (available from Aldrich), diphenyloxide disulfonate, naphthalene formaldehyde condensate, DOWFAX (available from Dow), dihexylsulfosuccinate, and dioctylsulfosuccinate, alkyl naphthalene sulfonate condensates, and salts thereof.

Examples of non-ionic surfactants include sorbitan esters, ethoxylated sorbitan esters, alkoxylated alkylphenols, alkoxylated alcohols, block copolymer ethers, and lanolin derivatives. In accordance with one embodiment, the surfactant comprises an alkylether block copolymer.

Non-limiting examples of commercially available non-ionic surfactants include SPAN 20, SPAN 40, SPAN 80, SPAN 65, and SPAN 85 (available from Aldrich); TWEEN 20, TWEEN 40, TWEEN 60, TWEEN 80, and TWEEN 85 (available from Aldrich); IGEPAL CA-210, IGEPAL CA-520, IGEPAL CA-720, IGEPAL CO-210, IGEPAL CO-520, IGEPAL CO-630, IGEPAL CO-720, IGEPAL CO-890, and IGEPAL DM-970 (available from Aldrich); Triton X-100 (available from Aldrich); BRIJ S10, BRIJ S20, BRIJ 30, BRIJ 52, BRIJ 56, BRIJ 58, BRIJ 72, BRIJ 76, BRIJ 78, BRIJ 92V, BRIJ 97, and BRIJ 98 (available from Aldrich); PLURONIC L-31, PLURONIC L-35, PLURONIC L-61, PLURONIC L-81, PLURONIC L-64, PLURONIC L-121, PLURONIC 10R5, PLURONIC 17R4, and PLURONIC 31R1 (available from Aldrich); Atlas G-5000 and Atlas G-5002L (available from Croda); ATLOX 4912 and ATLOX 4912-SF (available from Croda); and SOLUPLUS (available from BASF), LANEXOL AWS (available from Croda).

Non-limiting examples of cationic surfactants include mono alkyl quaternary amine, fatty acid amide surfactants, amidoamine, imidazoline, and polymeric cationic surfactants.

In some embodiments, the compositions according to the invention comprise a co-solvent in addition to water. Non-limiting examples of co-solvents that can be used include ethyl lactate, methyl soyate/ethyl lactate co-solvent blends (e.g., STEPOSOL, available from Stepan), isopropanol, acetone, 1,2-propanediol, n-alkylpyrrolidones (e.g., the AGSOLEX series, available from ISP), a petroleum based-oil (e.g., AROMATIC series and SOLVESSO series available from Exxon Mobil), isoparaffinic fluids (e.g. ISOPAR series, available from Exxon Mobil), cycloparaffinic fluids (e.g. NAPPAR 6, available from Exxon Mobil), mineral spirits (e.g. VARSOL series available from Exxon Mobil), and mineral oils (e.g., paraffin oil).

Examples of commercially available organic solvents include pentadecane, ISOPAR M, ISOPAR V, and ISOPAR L (available from Exxon Mobil).

In some embodiments, the treatment composition according to the invention may be formulated, mixed in a seed treater tank, combined on the seed by overcoating, or combined with one or more additional active ingredients. The additional active ingredients may comprise, for example, a pesticide or a biological agent. In some embodiments, the treatment composition comprises a composition according to the invention, e.g. an extract of a pepper plant of the genus Piper, and another pesticide, for example a nematicide, insecticide, fungicide, and/or herbicide. In some embodiments, the treatment composition comprises comprise a composition according to the invention, e.g. an extract of a pepper plant of the genus Piper, and a biological agent.

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In another embodiment, insecticides and nematicides include abamectin, aldicarb, aldoxycarb, bifenthrin, carbofuran, chlorantraniliprole, clothianidin, cyantraniliprole, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, tioxazafen, nitenpyram, oxamyl, permethrin, spinetoram, spinosad, spirodichlofen, spirotetramat, tefluthrin, thiacloprid, thiamethoxam, and thiodicarb.

In one embodiment, the insectide may be selected from the group consisting of clothianidin, thiamethoxam, tioxazafen, imidacloprid and combinations thereof.

Non-limiting examples of useful fungicides include aromatic hydrocarbons, benzimidazoles, benzothiadiazole, carboxamides, carboxylic acid amides, morpholines, phenylamides, phosphonates, quinone outside inhibitors (e.g. strobilurins), thiazolidines, thiophanates, thiophene carboxamides, and triazoles, Non-limiting examples of fungicides include acibenzolar-S-methyl, azoxystrobin, benalaxyl, bixafen, boscalid, carbendazim, chlorothalonil, cyproconazole, dimethomorph, epoxiconazole, fludioxonil, fluopyram, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, pyraclostrobin, sedaxane, silthiofam, tebuconazole, thifluzamide, thiophanate, tolclofos-methyl, trifloxystrobin, and triticonazole.

In one embodiment, the fungicide may be selected from the group consisting of ipconazole, metalaxyl, trifloxystrobin, pyraclostrobin, fluxapyroxad, sedaxane, fluopyram, mefenoxam, penflufen, azoxystrobin and combinations thereof.

Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins. Non-limiting examples of herbicides include acetochlor, clethodim, dicamba, flumioxazin, fomesafen, glyphosate, glufosinate, mesotrione, quizalofop, saflufenacil, sulcotrione, 2,4-D, trifloxysulfuron, and halo sulfuron.

In one embodiment, the herbicide may be selected from the group consisting of acetochlor, dicamba, glyphosate and combinations thereof.

Additional actives may also comprise substances such as, biological agents for pest control, microbial extracts, plant growth activators or plant defense agents. Non-limiting examples of biological agents include bacteria, fungi, beneficial nematodes, and viruses.

In certain embodiments, the biological agent can be a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comamonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobia, Serratia, Sphingobacterium, Stenotrophomonas, Variovorax, and Xenorhabdus. In particular embodiments the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomonas fluorescens.

In certain embodiments the biological agent can be a fungus of the genus Alternaria, Ampelomyces, Aspergillus, Aureobasidium, Beauveria, Colletotrichum, Coniothyrium, Gliocladium, Metarhizium, Muscodor, Paecilomyces, Bradyrhizobia, Trichoderma, Typhula, Ulocladium, and Verticillium. In another embodiment the fungus is Beauveria bassiana, Coniothyrium minitans, Gliocladium virens, Muscodor albus, Paecilomyces lilacinus, or Trichoderma polysporum.

In further embodiments the biological agents can be plant growth activators or plant defense agents including, but not limited to harpin, Reynoutria sachalinensis, jasmonate, lipochitooligosaccharides, salicylic acid and isoflavones. In another embodiment, the biological agent may be selected from the group consisting of Bacillus firmus.

Having described the embodiments in detail, it will be apparent that modifications and variations of the disclosure are possible without departing from the scope of the appended claims.

### EXAMPLES

The following non-limiting examples are provided for further illustration.

### Example 1: Preparation of Plant Extract Compositions

Different compositions according to the invention have been prepared by extraction from selected plant materials.

An extract of dried fruits of the pepper plant Piper nigrum, also known as peppercorn, is prepared in a two-steps extraction. The crushed peppercorns are first subjected to steam distillation, so as to produce a distillate. Then, in a second extraction step, the crushed peppercorns that have been subjected to steam distillation are then subjected to a solvent extraction, using a solvent mixture comprising ethylacetate, acetone and hexane. After sufficient extraction time, the solvents are then evaporated to yield a semi-solid extract known as resin. An oleoresin is then formed by mixing the distillate with the resin so as to obtain an oleoresin containing 38% of piperine and 18% of volatile oils.

Similar extracts, i.e. oleoresins, have also been prepared from chili (Capsicum annuum), cumin (Cuminum cyminum), clove (Syzygium aromaticum) and ginger (Zingiber officinale).

An extract of the garlic plant Allium sativum has also been prepared by steam distillation of crushed dried garlic cloves, yielding an oily distillate.

An additional composition according to the invention is a composition comprising 90% v/v of oleoresin from the pepper plant Piper nigrum, and 10% v/v of a distillate from cloves of the garlic plant Allium sativum. For the preparation of such composition, the desired volume percentage of oleoresin of the pepper plant Piper nigrum is mixed with the desired volume percentage of the distillate of cloves of the garlic plant Allium sativum.

### Example 2: Effect on Seed Germination

In order to assess the possible detrimental effects of some of the compositions prepared in example 1 on the capacity of seeds to germinate (i.e. seed germination), the various compositions have been tested at various doses on maize seeds.

The various compositions tested were the following:
Chili
Clove
Cumin
Black pepper
Ginger

Each composition has been used at 3 doses: 25 ml, 37.5 ml and 50 ml for 50 000 maize seeds.

In addition, a set of maize seeds has been treated with the existing commercial bird repellent solution, i.e. the compound Thiram (product Flowsan® used at the recommended dose of 3 ml/kg of maize seeds), as control.

Each composition has been tested on 400 maize seeds.

Each composition has been combined in a slurry mix with colorant, polymer, and water at the intended doses and allowed to mix thoroughly. The seeds were deposited in a lab treater (tumbler), into which the treatment slurry was injected by deposit on an atomizing disk. The seeds and the slurry were then allowed to tumble for about 30 seconds before being ejected into an appropriate container or storage bag.

Once treated with the various compositions at the various doses, the different seed lots have been stored for 6 months before being tested for germination.

The germination test has been a stringent one (including a cold period) and has consisted in sowing the seeds in soil under the following conditions: 7 days at 8° C. under obscurity (cold period), followed by 7 days at 25° C. under 17 h light photoperiod (artificial light by led lamps). Soil humidity has been maintained during the whole test. In order to avoid interferences of potential soil-borne diseases on the tests, all tested seed lots have been treated with a commercial fungicide composition containing the compound Thiram (product Pomarsol®) at sowing. Seed germination was measured at two distinct times:
First, at 7+2 days after sowing (i.e. 2 days after the end of the cold period at 8° C.), as a measurement of germination speed; and
Second, at 7+7 days after sowing (i.e. at the end of the period at 25° C.), as a measurement of germination capacity.

For the second measurement (i.e. at 7+7 days after sowing), the plantlets were removed and categorized as “Good”, “Abnormal” or “Non Germinated”.

The results of the germination tests are summarized in Table 1.

TABLE 1
Effect of the compositions on seed germination

| | | | Unaffected |
|---|---|---|---|
| | | Overall | germination capacity |
| | Germination speed | germination capacity | at 7 + 7 days |
| Compositions (dose | at 7 + 2 days | at 7 + 7 days | after sowing |
| per 50000 maize | after sowing | after sowing | (percentage of |
| seeds, except for | (percentage of | (percentage of | “Good” emerged |
| Flowsan ®) | emerged seeds) | emerged seeds) | seeds) |
| Flowsan 3 ml/ Kg | 97.50 | 97.00 | 95.25 |
| Chili 25 ml | 88.00 | 89.00 | 78.00 |
| Chili 37.5 ml | 87.00 | 91.50 | 84.00 |
| Chili 50 ml | 65.50 | 72.00 | 61.50 |
| Clove 25 ml | 93.50 | 95.50 | 89.00 |
| Clove 37.5 ml | 49.50 | 63.00 | 51.50 |
| Clove 50 ml | 22.00 | 36.00 | 30.50 |
| Cumin 25 ml | 90.00 | 91.50 | 82.50 |
| Cumin 37.5 ml | 87.50 | 93.50 | 84.50 |
| Cumin 50 ml | 74.00 | 79.50 | 68.00 |
| Black pepper 25 ml | 99.00 | 98.50 | 97.00 |
| Black pepper 37.5 ml | 99.50 | 98.50 | 97.00 |
| Black pepper 50 ml | 98.00 | 97.00 | 94.00 |
| Ginger 25 ml | 98.50 | 97.50 | 93.50 |
| Ginger 37.5 ml | 97.00 | 96.50 | 93.00 |
| Ginger 50 ml | 97.00 | 97.00 | 94.00 |

The results presented in Table 1 show that certain compositions are affecting seed germination more than others. The Black pepper composition is the least detrimental to seed germination, even at the highest doses tested. Ginger is only slightly detrimental to seed germination, but at a still acceptable rate. Cumin and Chili are moderately detrimental to seed germination. Clove is almost not detrimental to seed germination at the lowest dose tested, but becomes highly detrimental at the higher doses.

### Example 3: Effect on Seed Consumption by Birds

### 3.1. Repellency Test for a Selection of Compositions

A first test of the repellency power of various compositions has been made on pigeons. Corn seeds treated as in Example 2 have been used for the test, except that not all doses have been used in the repellency test. Only the doses that showed to be acceptable from a seed germination perspective have been tested in the repellency test. It would indeed not be of use to demonstrate the repellency power of certain compositions at certain doses if such compositions, at such doses, prove to be detrimental to the germination of the seeds.

The following compositions have therefore been used at the indicated doses:
Chili at the dose of 37.5 ml/50000 corn seeds
Clove at the dose of 25 ml/50000 corn seeds
Cumin at the dose of 37.5 ml/50000 corn seeds
Black pepper at the dose of 50 ml/50000 corn seeds
Ginger at the dose of 50 ml/50000 corn seeds

Thiram (Flowsan® at 3 ml/kg) and Methiocarb (Mesurol® at 150 ml/50000 corn seeds) were used as references.

In parallel, some control corn seeds were also used, that did not receive any of the compositions to be tested for repellency. However, all corn seeds, including the control seeds, did receive a basic treatment including a formulation slurry, the fungicide product Influx XL® (containing fludioxonil and metalaxyl-M) together with a seed coating solution (Peridiam®).

Pigeons have been tested for feed consumption in individual cages (aviaries). They were offered seeds as feed under “no choice” conditions, i.e. they were proposed only one type of seeds as feed.

On Day −1 (one day before the test), the birds were proposed 50 g of untreated maize seeds for 24 h, after which the remaining quantity of maize seeds was weighted. On Day 0, the birds were proposed 50 g of treated maize seeds for 24 h, after which the remaining quantity of maize seeds was also weighted.

After comparison of the weight of the remaining treated seeds with the weight of the remaining untreated seeds, the results are expressed as a percentage of reduction of feed consumption. The results are shown in Table 2.

TABLE 2
Effect of the compositions on seed consumption by pigeons

| Composition (dose per | |
|---|---|
| 50000 maize seeds, | Percentage (%) of reduction |
| except for Flowsan ®) | of feed consumption |
| Control | 91.9 |
| Flowsan ® 3 ml/kg | 99.1 |
| Mesurol ® 150 ml | 99.6 |
| Chili 37.5 ml | 99.3 |
| Clove 25 ml | 100 |
| Cumin 37.5 ml | 86.1 |
| Black pepper 50 ml | 97.9 |
| Ginger 50 ml | 100 |

These results confirmed that the market standards, i.e. Flowsan® and Mesurol®, have a strong efficacy as bird repellents. This test however revealed that the components other than the tested compositions may also have had an effect on the seed consumption by the pigeons. Indeed, the control also showed some significant bird repellency effect, which was likely due to one of the components added on all types of tested seeds, i.e. the slurry, the fungicide or the seed coating solution. As a consequence, although it was possible to discriminate the bird repellency effect of the different compositions, the results may not reflect the entire magnitude of that effect. Still, it was observed that chili, clove, black pepper or ginger have a good bird repellent effect, while cumin did not seem to have any (compared to the control).

### 3.2. Second Repellency Test of a Selection of Compositions

A similar experiment as in Example 3.1. was performed under the same conditions.

Here, the following compositions have been used at the indicated doses:
Cumin at three doses: 37.5 ml, 18.5 ml and 12.5 ml/50000 corn seeds
Ginger at three doses: 50 ml, 25 ml and 16.7 ml/50000 corn seeds

Thiram (Flowsan® at 3 ml/kg) was used as reference. In addition, all corn seeds, including control seeds, did receive a basic treatment including a formulation slurry, the fungicide product Influx XL® (containing fludioxonil and metalaxyl-M) together with a seed coating solution (Peridiam®).

The results are shown in Table 3.

TABLE 3
Effect of the compositions on seed consumption by pigeons

| Composition (dose per | |
|---|---|
| 50000 maize seeds, | Percentage (%) of reduction |
| except for Flowsan ®) | of feed consumption |
| Flowsan ® 3 ml/kg | 66 |
| Cumin 37.5 ml | 0 |
| Cumin 18.5 ml | 0 |
| Cumin 12.5 ml | 0 |
| Ginger 50 ml | 33 |
| Ginger 25 ml | 0 |
| Ginger 16.7 ml | 33 |
| Black pepper 90% - Garlic 10% | 86 |

These results confirm what was observed in Table 2, i.e. that the Ginger extract had a repellency effect on food consumption, while the Cumin extract did not have any.

The composition containing 90% Black pepper extract and 10% Garlic extract also confirmed the meaningful repellent effect of Black Pepper, also observed in Table 2.

### 3.3. Third Repellency Test of a Selection of Compositions

In a third trial, certain compositions have also been tested for their feeding repellency on pigeons.

The test procedure was however slightly changed compared to the trials in Examples 3.1 and 3.2. Indeed, instead of simply comparing the effect of the tested compositions against the untreated seeds offered to the pigeons at Day-1, here a set of the pigeons was also offered untreated seeds at Day 0 in parallel to the set of pigeons being offered the seeds treated with a composition. The results for the set of pigeons having received the treated seeds are therefore compared to the results for the set of pigeons having received the untreated seeds in parallel at Day 0 (instead of the results for the set of the pigeons having received the untreated seeds at Day-1). Two trials under this setting have been performed with different compositions.

Trial 1:
Black pepper at the dose of 40.5 ml/50000 corn seeds
Garlic at the dose of 4.5 ml/50000 corn seeds
Mixture of Black pepper (90%) and garlic (10%) at the dose of 45 ml/50000 corn seeds

Trial 2:
Black pepper at the dose of 40.5 ml/50000 corn seeds
Garlic at the dose of 4.5 ml/50000 corn seeds
Mixture of Black pepper (90%) and garlic (10%) at the dose of 45 ml/50000 corn seeds
Thiram at the dose of 45 ml/50000 corn seeds

The results are shown in Table 4.

TABLE 4
Effect of the compositions on seed consumption by pigeons

| | |
|---|---|
| Composition (dose per | Percentage (%) of reduction |
| 50000 maize seeds) | of feed consumption |

Trial 1

| | |
|---|---|
| Black pepper 40.5 ml | 64 |
| Garlic 4.5 ml | 2.1 |
| Black pepper (90%) and | 66 |
| garlic (10%) 45 ml | |

Trial 2

| | |
|---|---|
| Black pepper 40.5 ml | 54 |
| Garlic 4.5 ml | 2.6 |
| Black pepper (90%) and | 69.1 |
| garlic (10%) 45 ml | |
| Thiram 45 ml | 65 |

These trials confirmed that the reference product Thiram has a good repellency effect on seed consumption by the pigeons. It has also demonstrated the similarly good efficacy of the black pepper composition, whereas the garlic composition was shown to have no such repellency effect. These results explained that the good efficacy of the mixture of black pepper (90%) and garlic (10%) was mostly due to the black pepper component of the mixture.

### Example 4: Field Trial Measuring the Effect on Seed Consumption by Free-Living Birds

The trial was conducted in commercially drilled maize fields in in the region Zuelpicher Boerde, Rhineland in Northrhine-Westphalia, western Germany. The distance between fields was minimum 500 m.

The purpose of the field trial was to observe whether different bird species using freshly drilled maize fields show any preference or avoidance of maize seeds dressed with a repellent versus untreated maize seeds. Accordingly, the trial was designed to allow a choice experiment with four options (two options treated with a Black pepper composition according to the invention at two different dose rates, one treated with Mesurol as reference, and one untreated) offered to wild birds. The different maize seeds were offered at ‘bait stations’ and bird visits were recorded with motion-triggered cameras. Visiting bird species and quantities of seeds taken were assessed.

Four study fields were selected for set-up of bait stations offering the differently treated (or untreated) maize seeds (hereafter named treatments). On each of the 4 study fields, 4 bait stations each with the 4 different treatments were installed (=the four bait stations being designated one ‘bait station set’) in a randomized design. The treatments were Black pepper composition at dose rate 1 (60.75 ml/50000 seeds), Black pepper composition at dose rate 2 (101.25 ml/50000 seeds), Standard treatment (Mesurol) and untreated. The distance between bait stations within one ‘set’ was 5-10 m.

Bait stations consisted of a ground area of about one square meter in which approximately 1 kg of seeds was placed in the center. Each single bait station was monitored by motion and infrared sensitive camera (Browning BTC-8A) powered by batteries (AA). Video footages were recorded after a camera was triggered by a moving animal. The cameras were set in the morning before dawn and switched off in the evening. Recording was repeated for 7 consecutive days. Maize seeds were exchanged daily.

The video footages were later decoded, sorted and the bird species, number of bird visits and number of seeds eaten from individual treatments as well as other behavior were recorded.

Results of the video recordings compiled from the four test fields are summarized in Table 5 hereafter:

TABLE 5
Results of video recording in field trial
Total number of bird visits and number of seeds eaten
(n = 2675 hours of video observation)

| | Total number of visits at bait | | | | | | | |
|---|---|---|---|---|---|---|---|---|
| | stations | | | | Total number of seeds eaten | | | |
| Species | UT | ST | BP1 | BP2 | UT | ST | BP1 | BP2 |
| Blackbird | 3 | 13 | 1 | 5 | 0 | 0 | 0 | 0 |
| Blue tit | 6 | 0 | 3 | 2 | 0 | 0 | 0 | 0 |
| Carrion crow | 222 | 26 | 20 | 21 | 760.5 | 0 | 0 | 0 |
| Chaffinch | 22 | 30 | 20 | 2 | 2.5 | 0 | 0 | 0 |
| Common pheasant | 90 | 68 | 50 | 36 | 1739 | 0 | 0 | 4.5 |
| Common starling | 9 | 6 | 9 | 4 | 3 | 0 | 0 | 0 |
| Great tit | 16 | 5 | 3 | 1 | 0 | 0 | 0 | 0 |
| Jay | 8 | 2 | 4 | 3 | 4 | 0 | 0 | 1 |
| Magpie | 4 | 0 | 0 | 0 | 6 | 0 | 0 | 0 |
| Mistle thrush | 1 | 1 | 2 | 0 | 0 | 0 | 0 | 0 |
| Skylark | 1 | 0 | 0 | 0 | 0 | 0 | 0 | 0 |
| Song thrush | 0 | 0 | 1 | 1 | 0 | 0 | 0 | 0 |
| Stock dove | 3 | 2 | 5 | 5 | 0 | 0 | 0 | 0 |
| Wheatear | 0 | 0 | 4 | 1 | 0 | 0 | 0 | 0 |
| White wagtail | 9 | 3 | 8 | 10 | 0 | 0 | 0 | 0 |
| Woodpigeon | 358 | 44 | 59 | 45 | 4224 | 0 | 1 | 4 |
| Yellowhammer | 50 | 8 | 11 | 9 | 20.5 | 0 | 0 | 0 |
| TOTAL | 802 | 208 | 200 | 145 | 6759.5 | 0 | 1 | 9.5 |

UT = untreated,
ST = Standard,
BP1 = Black pepper dose rate 1,
BP2 = Black pepper dose rate 2

In total, 17 bird species visited the bait stations and in total 1355 visits were recorded. Woodpigeons, Carrions crows and Common pheasants were the most abundant visitors. Some of the birds were more abundant in certain fields. Also, some of the visiting birds are not strict granivorous, or if so, may not have maize seeds as their preferred feed, which may explain certain low levels of visits (also for untreated) compared to others.

The treatment of the maize seed showed a clear effect on the analyzed parameters. Individuals showed a clear preference of the untreated seeds:

Visits of the feeding stations were influenced by the type of maize seeds. Far more birds visited the bait stations offering untreated maize seeds than the treated seeds. Thus, the treatment has a strong repellent effect even before birds investigate the seeds closer.

Also, at the ‘next level’ of a potential ‘repellent effect’, the proportion of visitors that actually handled maize seeds, birds showed a clear preference for the untreated seeds.

And finally, the proportion of handled maize seeds that were subsequently swallowed was significantly higher for the untreated seeds than in all treatment groups. Consequently, the number of consumed seeds was highest for feeding stations with untreated maize seeds. Hence at all three ‘levels’ for a ‘potential treatment effect’ untreated seeds were detected.

1. A viable plant propagation material covered with a composition comprising a plant extract selected from the group consisting of: (i) an extract of a pepper plant of the genus Piper, and (ii) an extract of a ginger plant Zingiber officinale.

2. The plant propagation material of claim 1, wherein the plant extract is an oleoresin.

3. The plant propagation material of claim 2, wherein the composition is a composition comprising an extract of a plant of the genus Piper.

4. The plant propagation material of claim 3, wherein the composition comprises an extract of the plant Piper nigrum.

5. The plant propagation material of claim 4, wherein the composition comprises an extract of the fruits of the plant Piper nigrum.

6. A viable plant propagation material covered with a composition comprising piperine.

7. A viable plant propagation material according to claim 1, covered with a composition comprising (i) at least 50% v/v of an extract of a plant of the genus Piper and (ii) up to 50% v/v of at least one extract of another plant having a bird repellent effect.

8. The plant propagation material of claim 7, wherein the extract of another plant having a bird repellent effect is an extract of the garlic plant Allium sativum.

9. The plant propagation material of claim 8, wherein the extract of the garlic plant Allium sativum is an oil obtained by steam distillation of crushed cloves.

10. The plant propagation material of claim 1, wherein the plant propagation material is a seed.

11. The plant propagation material of claim 1, wherein the plant propagation material is a fruit.

12. The plant propagation material of claim 10, wherein the plant propagation material is a seed maturing on the plant producing it.

13. A container containing the plant propagation material according to claim 1.

14. A method for protecting plant propagation material from free-living birds, comprising treating the plant propagation material with a composition comprising a plant extract selected from the group consisting of: (i) an extract of a pepper plant of the genus Piper, and (ii) an extract of a ginger plant Zingiber officinale, to provide the viable plant propagation material of claim 1.

15. The method of claim 14, wherein the plant propagation material is a seed, a fruit or a seed or fruit maturing on the plant producing it.

16. A viable plant propagation material according to claim 6, covered with a composition comprising (i) at least 50% v/v of an extract of a plant of the genus Piper and (ii) up to 50% v/v of at least one extract of another plant having a bird repellent effect.

17. A method for protecting plant propagation material from free-living birds, comprising treating the plant propagation material with a composition comprising piperine, to provide the viable plant propagation material of claim 6.

18. The plant propagation material of claim 11, wherein the plant propagation material is a fruit maturing on the plant producing it.
